(19) United States
(12) Patent Application Publication
(10) Pub. No.: US 2014/0110616 A1
(43) Pub. Date: Apr. 24, 2014

(54) INTEGRAL HANDLE FOR A VALVE

(71) Applicant: EATON CORPORATION, Cleveland, OH (US)

(72) Inventor: Gilbert Peter Freeth, San Dimas, CA (US)

(73) Assignee: EATON CORPORATION, Cleveland, OH (US)

(21) Appl. No.: 14/060,899

(22) Filed: Oct. 23, 2013

Related U.S. Application Data
(60) Provisional application No. 61/717,206, filed on Oct. 23, 2012.

(51) Int. Cl. F16K 35/02

(52) U.S. Cl. CPC F16K 35/027
USPC 251/288

(57) ABSTRACT

A method for controlling the flow of fluid includes providing a valve assembly including a ball valve having a spherical disk, a substantially circular handle connected to the spherical disk ball valve that is configured to move between a first position and a second position relative to the ball valve, and a biasing member configured to bias the substantially circular handle towards the ball valve. In order to control the flow of the fluid, the substantially spherical handle may be moved from the first position to the second position.

This application claims priority to U.S. Provisional Application No. 61/717,206 filed on Oct. 23, 2012.

### FIELD OF INVENTION

The present disclosure relates to a handle for a valve. More particularly, the present disclosure relates to an integral handle for a valve that controls a fluid flow.

### BACKGROUND

Known valves employ an elongated spanner to open or close the valve. In some instances, the spanner is removable and can be inserted into a key slot to rotate the valve. A ball valve is one example of a valve that may employ an elongated spanner. A ball valve includes a spherical disc having a hole, or port, through the middle such that when the port is aligned with both ends of the valve, flow will occur. When the valve is closed, the hole is perpendicular to the ends of the valve, and flow is blocked. The elongated spanner can be aligned with the port, thereby indicating the valve's position. It was thought that an elongated spanner was required to provide a sufficient lever arm to allow a user to produce the necessary torque to open or close the valve. Other quarter-turn valves, and other valves may employ a similarly elongated spanner.

### SUMMARY OF THE INVENTION

In one embodiment, a method for controlling the flow of fluid includes providing a valve assembly comprising a ball valve having a spherical disk, a substantially circular handle connected to the spherical disk ball valve that is configured to move between a first position and a second position relative to the ball valve, and a biasing member configured to bias the substantially circular handle towards the ball valve. In order to control the flow of the fluid, the substantially spherical handle may be pulled away from the ball valve and moved from the first position to the second position and locked in place in the second position.

The substantially circular handle may be configured to be locked in either the first position or the second position by inserting a locking pin disposed on the substantially circular handle in to a first slot within the valve assembly corresponding to the first position or a second slot within the valve assembly that corresponds to the second position. When the substantially spherical handle is pulled away from the ball valve further the locking pin is removed from the first slot and when the substantially circular handle is moved to the second position, the locking pin is disposed within the second slot.

In another embodiment, the ball valve assembly may also include indicia that indicate if the substantially circular handle is in the first position or the second position. In one embodiment, the indicia are configured to be viewed through a through-hole disposed within the substantially circular handle. In another embodiment, the indicia are placed on the substantially circular handle.

In yet another embodiment, the valve assemble may also include at least one lobe disposed about an outer circumference of the substantially circular handle or a handle extension disposed in a center portion of the substantially circular handle that is configured to receive a tool capable of providing additional torque in order to move the substantially circular handle from the first position to the second position. The handle extension may be disposed in a recess within the center portion of the substantially circular handle.

### BRIEF DESCRIPTION OF DRAWINGS

The accompanying drawings, which are incorporated in and constitute a part of the specification, illustrate various example systems and components that illustrate various example embodiments of aspects of the invention. It will be appreciated that the illustrated element boundaries represent one example of the boundaries. One of ordinary skill in the art will appreciate that one element may be designed as multiple elements or that multiple elements may be designed as one element. An element shown as an internal component of another element may be implemented as an external component and vice versa. The drawings may not be to scale and the proportion of certain elements may be exaggerated for the purpose of illustration.

FIG. 1 is a perspective view of one embodiment of a ball valve and integral handle assembly;

FIG. 2 is a perspective view of one embodiment of a handle;

FIG. 3 is a top view of the handle of FIG. 2;

FIG. 4 is a side view of the handle of FIG. 2; and

FIG. 5 is a partial cross-section of the ball valve and integral handle assembly of FIG. 1.

### DETAILED DESCRIPTION

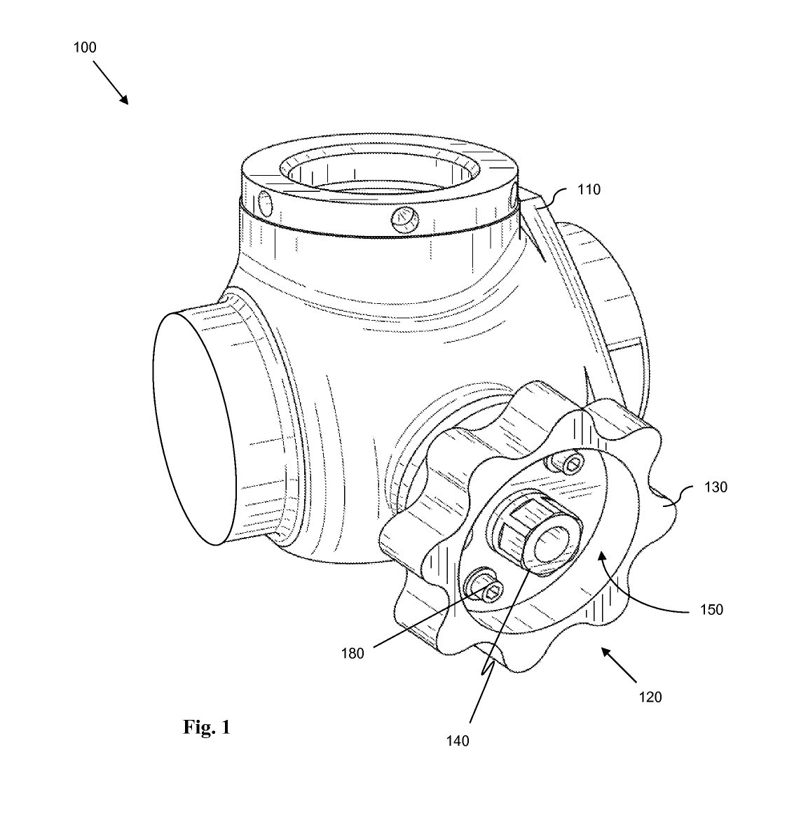

FIG. 1 is a perspective view of one embodiment of a valve assembly 100 including a ball valve 110 and an integral handle 120. The ball valve 110 includes a spherical disc (not shown) having a hole through the middle such that when the hole is aligned with both ends of the valve, flow will occur. The handle 120 is a generally circular handle having a plurality of lobes 130 disposed thereon. In the illustrated embodiment, the handle 120 includes eight lobes 130. In alternative embodiments, the handle may include any number of lobes. It should be understood that the number of lobes may be varied for ergonomic purposes. For example, it may be desirable for a smaller handle to have fewer lobes, and for a larger handle to have more lobes. While the illustrated lobes 130 define a smooth curve, it should be understood that the lobes may have straight portions, or follow an irregular curve.

The inventor found that if the compression of the valve were reduced, less torque was required to turn the valve. Surprisingly, in many applications, the compression of the valve can be reduced without adversely affecting the performance of the valve. In certain applications, sufficient torque may be generated to turn a valve without the use of an elongated spanner or other device to provide an additional lever arm. In the illustrated embodiment, the handle 120 can be manually turned by hand, without the use of tools, thereby rotating the ball valve between a first and second position. In one embodiment, the first position is an open position and the second position is a closed position. In an alternative embodiment, when the valve is in the first position, it directs fluid flow in a first direction and when the valve is in the second position, it directs fluid flow in a second position.

The handle 120 further includes a hexagonal handle extension 140 located substantially at the center of the handle. The hexagonal handle extension 140 is configured to receive a socket wrench (not shown), so that if a user is unable to generate sufficient torque to manually turn the handle 120, the user may employ a socket wrench to provide an additional lever arm. In alternative embodiments (not shown), the handle may include a handle extension or recess of any shape, to receive any standard or custom shaped tool that may provide an additional lever arm.

The handle 120 also includes a recess 150. In the illustrated embodiment, the hexagonal handle extension 140 is disposed in the recess 150 such that it does not extend beyond a top surface of the handle 120. This may be done for safety purposes. In an alternative embodiment (not shown), the handle does not include a recess.

Although FIG. 1 depicts a ball valve assembly, and the integral handle 120 may be particularly well-suited for a ball valve, it should be understood that the integral handle 120 may be employed on a butterfly valve, a plug valve, or other quarter-turn valves. It should be further understood that the integral handle 120 may be employed on any type of valve assembly.

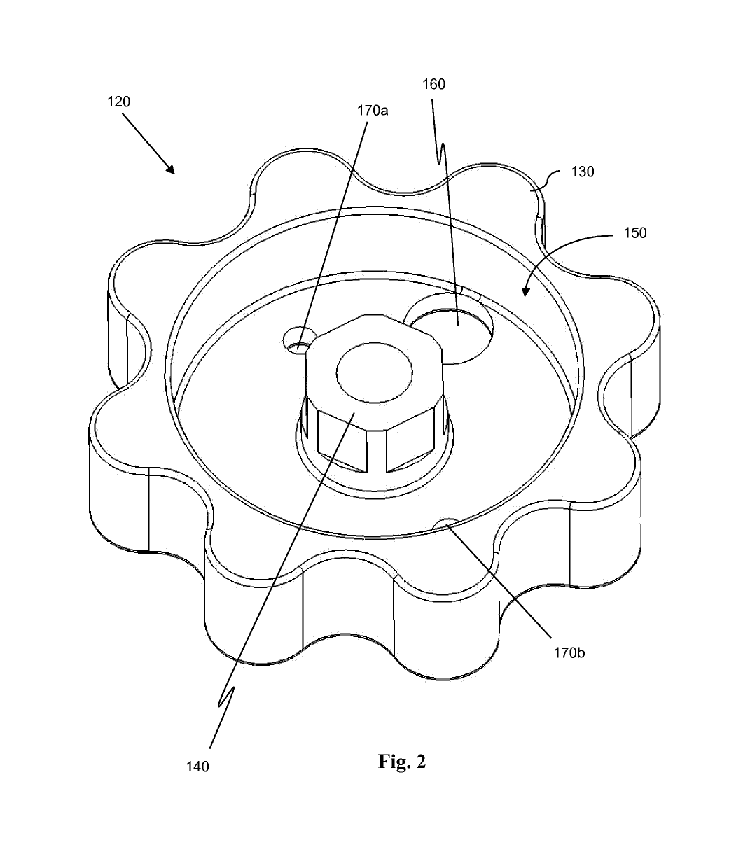

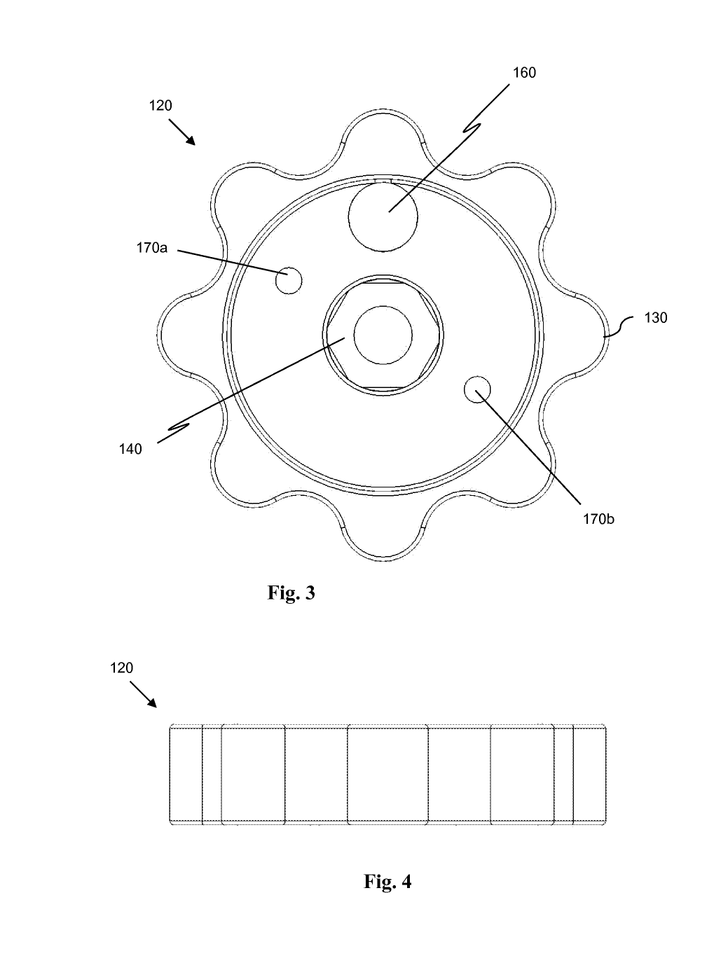

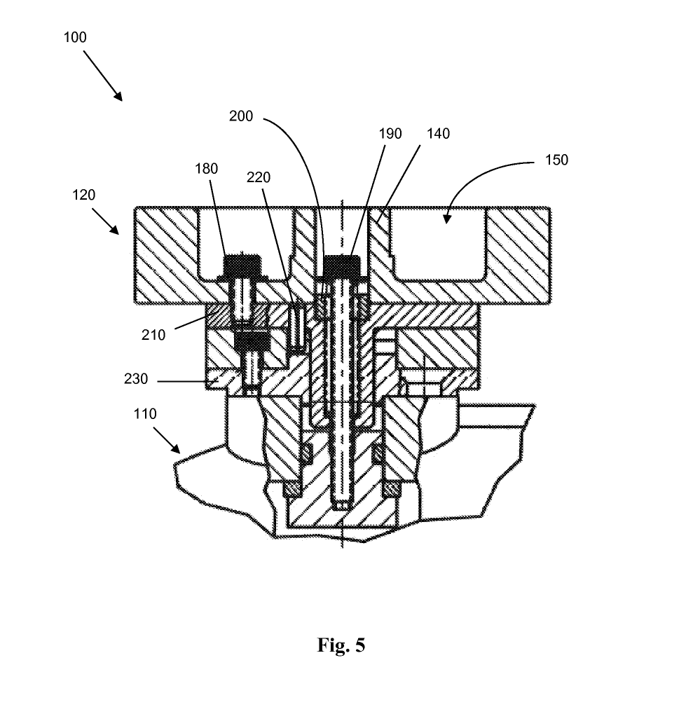

Additional details of the handle 120 are shown in FIGS. 2-4. FIG. 2 is a perspective view of the handle 120. FIGS. 3 and 4 are top and side views, respectively, of the handle 120. The handle 120 includes a large through-hole 160 that allows a user to view a surface of the valve that is below or behind the handle 120. The valve may have an indicia disposed thereon, that is aligned with the first position and the second position of the through-hole 160. For example, the valve 110 has the letter “R” embossed thereon at a location below the first position of the through-hole 160. Accordingly, when the letter “R” is visible to the user through the through-hole 160, it serves as an indicator to the user that the handle 120 is in the first position. It should be understood that any indicia may be employed on the valve, including letters, numbers, symbols, and any combination thereof. The indicia may be embossed, stamped, etched, drawn, applied by an adhesive, or otherwise disposed on the valve.

In an alternative embodiment (not shown), the handle does not include a large through-hole. Instead, indicia may be disposed on the handle to indicate its position. For example, an arrow may be disposed on the handle to indicate the direction of fluid flow.

The handle 120 further includes a pair of small holes 170a,b configured to receive a pair of locking screws 180 (as shown in FIG. 5).

FIG. 5 is a partial cross-section of the assembly 100 of FIG. 1, including the valve 110 and the integral handle 120. As can be seen from this view, the handle 120 is rotatably connected to the valve 110 by a central pin 190. Additionally, a biasing member 200 biases the handle 120 towards the valve 110. An example of a biasing member is a spring. However, it should be understood that any biasing member may be employed.

The handle 120 further includes a locking pin 220 configured to be received in slots of aperture 230. It should be understood that any number of slots may be employed on aperture 230. In an alternative embodiment, the handle does not include receiving slots, but instead includes projections that extend from a bottom surface. In another alternative embodiment, the handle does not include a locking pin or locking projections.

The locking screws 180 are disposed through the small holes 170a,b of the handle 120, and connected to aperture 210. The locking pin 220 on aperture 210 is configured to be received in corresponding slots on aperture 230 of the valve 110. A first slot of aperture 230 is positioned to receive the locking pin 220 when the handle 120 is in the first position. A second slot of aperture 230 is positioned to receive the locking pin 220 when the handle is in the second position.

In operation, a user will pull the handle 120 away from the valve 110, against the force exerted by the biasing member 200. The user will then turn the handle clockwise or counter-clockwise to either the first position or the second position. When the handle is in the first or second position, the locking pin 220 will be aligned with the corresponding slot of aperture 230 and the large through-hole 160 will be aligned with indicia disposed on the valve. The user may then release the handle 120, and the biasing member 200 will bias the handle 120 towards the valve 110, such that the locking pin 220 is received in the slot of corresponding aperture 230.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

1. A valve assembly comprising:
a ball valve having a spherical disk;
a substantially circular handle connected to the spherical disk ball valve that is configured to move between a first position and a second position;
a biasing member configured to bias the substantially circular handle towards the ball valve; and
wherein the assembly is configured to lock the substantially circular handle in either the first position or the second position.

2. The valve assembly of claim 1, wherein the substantially circular handle further comprises at least one locking pin that is configured to be received in a corresponding slot disposed within the valve assembly.

3. The valve assembly of claim 1, wherein the valve assembly further comprises a first slot that is configured to receive a locking pin when the substantially circular handle is in the first position and a second slot that is configured to receive the locking pin when the substantially circular handle is in the second position.

4. The valve assembly of claim 1, wherein the substantially circular handle further comprises at least one lobe.

5. The valve assembly of claim 1, wherein the valve assembly further comprises a handle extension disposed in a center portion of the substantially circular handle; wherein the handle extension is configured to receive a tool capable of providing additional torque in order to move the substantially circular handle from the first position to the second position.

6. The valve assembly of claim 5, wherein the handle extension is disposed in a recess within the center portion of the substantially circular handle.

7. The valve assembly of claim 1, wherein the valve assembly comprises indicia configured to indicate if the substantially circular handle is in the first position or the second position.

8. The valve assembly of claim 7, wherein the substantially circular handle further comprises a through-hole and wherein the indicia of the valve assembly are visible through the through-hole.

9. The valve assembly of claim 1, wherein the biasing member is a spring.

10. A method for controlling the flow of fluid, comprising:
providing a valve assembly comprising a ball valve having a spherical disk; a substantially circular handle connected to the spherical disk ball valve that is configured to move between a first position and a second position relative to the ball valve; and a biasing member configured to bias the substantially circular handle towards the ball valve;
pulling the substantially spherical handle away from the ball valve;
moving the substantially circular handle from the first position to the second position; and
locking the substantially circular handle in the second position.

11. The method of claim 10, wherein the substantially circular handle is configured to be locked in either the first position or the second position by inserting a locking pin disposed on the substantially circular handle in to a first slot within the valve assembly that corresponds to the first position or a second slot within the valve assembly that corresponds to the second position.

12. The method of claim 11, wherein the step of pulling the substantially spherical handle away from the ball valve further comprises removing the locking pin from the first slot and wherein the step of locking the substantially circular handle in the second position further comprises inserting the locking pin in to the second slot.

13. The method of claim 10, wherein the method further comprises providing indicia on the ball valve assemble that indicate if the substantially circular handle is in the first position or the second position.

14. The method of claim 13, wherein the indicia are configured to be viewed through a through-hole disposed within the substantially circular handle.

15. The method of claim 10, wherein the valve assemble further comprises at least one lobe disposed about an outer circumference of the substantially circular handle.

16. The method of claim 10, wherein the valve assembly further comprises a handle extension disposed in a center portion of the substantially circular handle that is configured to receive a tool capable of providing additional torque in order to move the substantially circular handle from the first position to the second position; and wherein the step of moving the substantially circular handle from the first position to the second position further comprises attaching the tool to the handle extension.

17. The method of claim 17, wherein the handle extension is disposed in a recess within the center portion of the substantially circular handle.
